(19) United States
(12) Patent Application Publication
(10) Pub. No.: US 2020/0009897 A1
(43) Pub. Date: Jan. 9, 2020

(54) Folio Organizer with Power

(71) Applicant: Nicole Mehringer, Playa del Rey, CA (US)

(72) Inventor: Nicole Mehringer, Playa del Rey, CA (US)

(21) Appl. No.: 16/028,289

(22) Filed: Jul. 5, 2018

(51) Int. Cl. B42F 11/00; A45C 13/00; A45C 13/02; B42F 7/06

(52) U.S. Cl. CPC B42F 11/00; A45C 13/001; A45C 2011/002; B42F 7/06; A45C 13/023

(57) ABSTRACT

An electronic aware folio includes structure for holding a number of different electronics devices, and also includes a charger for those electronics devices at different levels in the folio, accessible from different sides. The folio has first and second sides hinged together on a spine. The first side, has a plurality of interconnected webbed pockets, including a first pocket adapted for holding a first electronic device, and accessible from a first side of the folio, a second pocket, above the first pocket, and accessible from a second side of the folio opposite to the first side, the first and second pockets sized for holding different sized electronic devices. A third pocket is adapted for holding charge cords, and adapted for allowing the charge cords to extend to both of the first pocket and the second pocket. A zippered pocket, at least part of which having the thickness of the first pocket and the second pocket combined, and having an inside area of the size of the combined thickness of the first pocket and the second pocket. A spine, having at least one battery attached thereto, and having at least one output port,where the third pocket includes a through hole, which leads to an area of the spine, enabling the charging cords to receive power from the battery. The second side is hingedly connected connected to the spine and holding a structure for taking notes thereon.

### BACKGROUND

Various personal effects can be carried in various ways. Men conventionally carry certain personal effects in their pocket(s), such as wallet, keys and other personal effects. Women, however, do not conventionally carry such things in their pocket and typically will carry a pocketbook. However, both the pocket and the purse are poorly suited for carrying various items that are useful to people in the business world.

Folios and legal pad holders are also known, and look more professional in certain circumstances than other alternatives. However, these folios typically only include a pad of paper and a place to hold a pen.

### SUMMARY

Embodiments disclosed herein address these issues based on the inventor's need for a modified folio which holds electronic equipment as well as the user's personal belongings. This is done using a stacked mesh pocket system.

An embodiment also describes how the spine of the folio, can house batteries for running and charging the electronic equipment, as well as certain processing capability.

### BRIEF DESCRIPTION OF THE DRAWINGS

In the Drawings:

FIG. 1 shows a view of the folio in the open position

FIG. 2 shows a side view of the folio showing the levels;

FIG. 3 shows a side view from the top, showing items packed in the multi level folio;

FIG. 4 shows how items can be inserted into the folio from alternate directions; and

FIG. 5 shows a side view from the bottom, showing the power connections.

### DETAILED DESCRIPTION

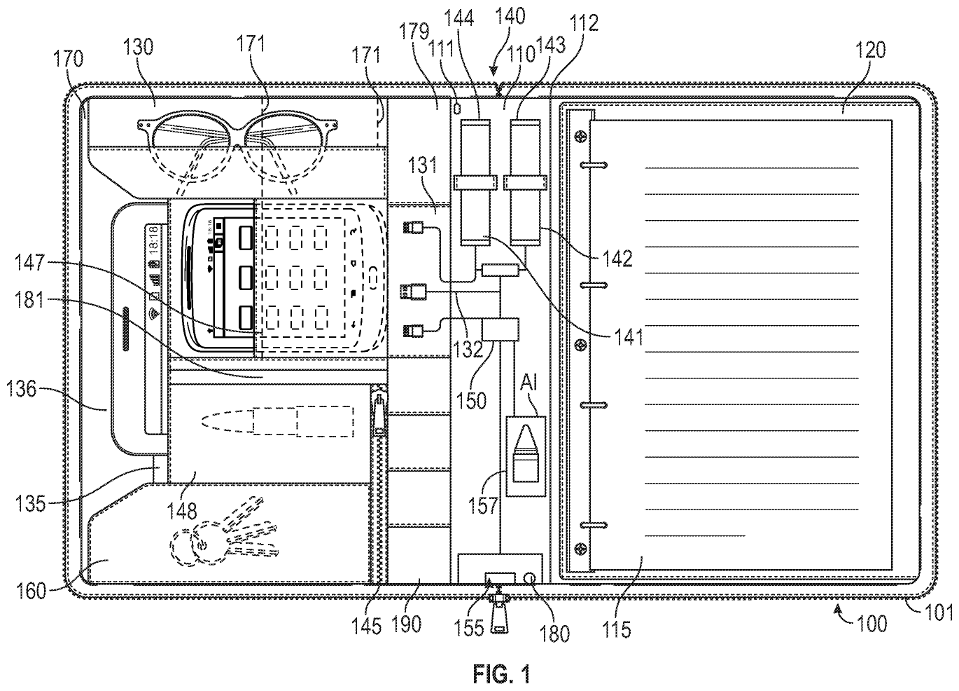

Embodiments describe a special portfolio, with an expanded spine area, where the expanded spine includes a stacked mesh system on one side that holds multiple different items in multiple different levels of the portfolio. FIG. 1 illustrates an embodiment which shows the portfolio in the open configuration. The portfolio 100 includes an expanded width spine 110 which hinges at 111 and 112 to respective sides 120 and 130 that are attached to the spine 110. A first side 120 can hold, as conventional, a pad of paper shown as 115. In an alternative embodiment described herein, the first side 120 can also or alternatively include an electronic display. The first side more generally is for taking notes which could be on a pad of paper, or could be a built-in electronic device, with a small display and keyboard or voice-recognition microphone. In an embodiment, the first and second sides can be connected via a closure mechanism, for example can be closed using the zipper 101, or alternatively can be closed by a catch or a latch or by a Velcro holder.

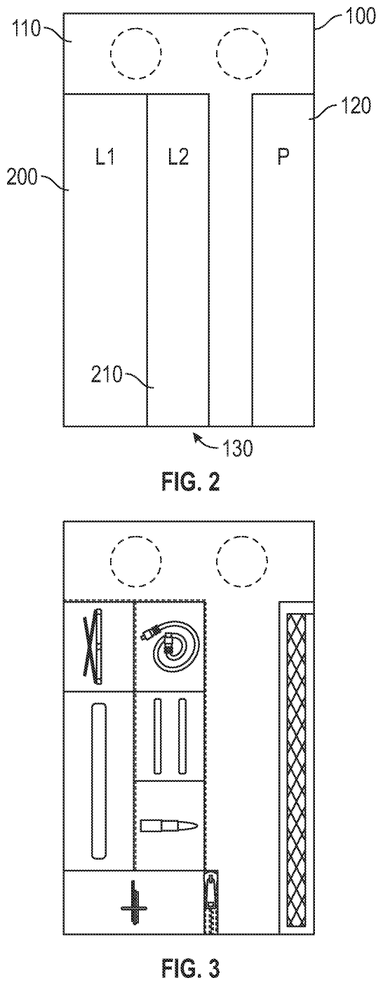

The second side 130 is thicker than the first side by virtue of having multiple levels of mesh and/or expandable pockets. FIG. 2 illustrates a top view of the portfolio 100, showing the first side 120, and the second side 130. In this embodiment, the second side 130 is much wider than the first side 120, since the first side includes two levels 200, 210 stacked one over the other in various ways, using mesh netting and other structure to hold one item on top of the other. The spine 110 also includes an electronics section 140 which in this embodiment includes batteries 141, 142, held in by elastic straps such as 143 into battery holder contacts such as 144. The batteries connect to electronic circuitry 150, which drives a 5V USB output shown as 150, 155 for the external USB output.

The batteries may also drive an AI electronic circuit shown as 157 which is used as described herein. FIG. 1 shows only two batteries, however there can alternatively be more batteries, such as four batteries or the like. In one embodiment, the batteries can be 18650 style lithium batteries.

The second side 130 includes a number of stacked pockets. Each pocket can be formed of mesh with an elastic edge. The first section 131 is provided for charging cables and and includes an opening 132 to allow the charging cables to extend through the charging cable opening 132 to the internal USB connection 156 to provide power on the charging cable(s). These cables can be stored in the pocket 131 coiled up, so that they can be uncoiled to extend to any of the electronic devices in any of the pouches as referred to herein.

Another lower pouch 135 at the lowest most level of the folio, and is intended to hold, as shown, a tablet size computer 136, inserted from the left to right. Directly on top of that lower pouch 135 is a half-size pouch 147 intended to hold one or more mobile telephones, inserted from the right to the left. Also above the pouch 135 is a zippered compartment with a zipper 145, leading to a compartment 146 intended to hold sundries such as lipstick and other kinds of makeup. There is also a double width key pouch 160, which can hold bulky items such as keys. The top of the folio has a pouch 170 for glasses, with an opening at 171, which allows the glasses to be inserted right to left, and held completely within the pouch to avoid scratching. A soft case can be held within the section 172.

In one embodiment, the spine can be 2 inches in width, thus enabling holding the multiple batteries. There can also be a charging port 180 which can enable applying external power to charge the batteries.

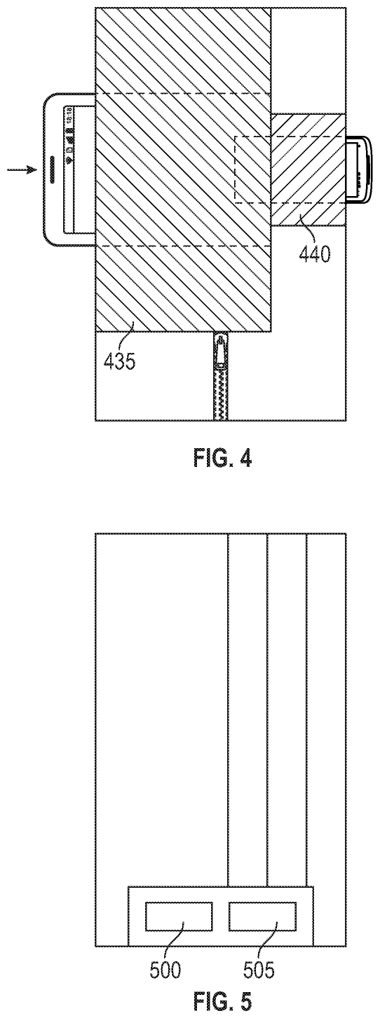

In one embodiment, FIG. 4 illustrates how different pouches can be loaded from different sides. The tablet pouch 135 is shown as being loaded from the left, with the tablet underneath the pouch. The cellular phone pouch is loaded from the right. The cord pouch is loaded from the left so that the cords can extend from the power source in the spine toward the various electronic devices, e.g., to plug into the tablet and into the cellular phone. In FIG. 1 there are also spots for holding identification cards and business card shown generically as 190.

FIG. 5 shows the opposite side from the bottom side view, showing that there is a USB output which can be connected to 500, and a charging port 505.

In one embodiment, the electronics 150 includes an artificial intelligence agent which allows carrying out simple tasks by phone. In one embodiment, the system is called the Patt, and simple audio tasks can be carried out by saying “hey Patt” followed by certain requests. This can be powered, for example, using Siri™, or Alexa™ artificial intelligence engines. This may require a wifi connection for the engine 150.

The system can automatically determine the level of its batteries, for example, Patt can tell you the time, information from a calendar that may be stored in the electronics, or information on the charge level of the electronics which are stored in the device, assuming those electronics used wireless devices that communicate their information to the electronics.

In one embodiment, the cellular phone pouch includes a Velcro closure 181, which enables changing the size of the cellular phone pouch to different sizes to accommodate different size telephones.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A folio, comprising:
a first side, having a plurality of interconnected webbed pockets,
including a first pocket adapted for holding a first electronic device, and accessible from a first side of the folio, a second pocket, above the first pocket, and accessible from a second side of the folio opposite to the first side, the first and second pockets sized for holding different sized electronic devices, a third pocket, adapted for holding charge cords, and adapted for allowing the charge cords to extend to both of the first pocket and the second pocket, and a zippered pocket, at least part of which having the thickness of the first pocket and the second pocket combined, and having an inside area of the size of the combined thickness of the first pocket and the second pocket,
a spine, having at least one battery attached thereto, and having at least one output port,
where the third pocket includes a through hole, which leads to an area of the spine, enabling the charging cords to receive power from the battery; and
a second side, hingedly connected connected to the spine and holding a structure for taking notes thereon.

2. The folio as in claim 1, wherein a first part of the zippered pocket is over the first electronic device to provide a reduced thickness part, and a second part of the zippered pocket is adjacent the first electronic device, to provide an increased thickness part.

3. The folio as in claim 1, wherein the at least one battery in the spine is held by elastic holders, and are held in battery connector assemblies.

4. The folio as in claim 1, further comprising an artificial intelligence agent, powered by the batteries and accepting voice commands and providing spoken responses to the voice commands.

5. The folio as in claim 4, wherein the artificial intelligence agent enables communicating a charge level of the at least one battery.

6. The folio as in claim 4, wherein the artificial intelligent agent enables communicating the charge level of the electronic devices in the folio.

7. The folio as in claim 1, further comprising an external charging port which enables charging an electronic device without opening the folio, said external charging port accessible via a side edge of the spine without opening the folio.

8. The folio as in claim 1, wherein the first and second sides can be attached together by a closure mechanism.
